(19) United States
(12) Patent Application Publication
(10) Pub. No.: US 2018/0252272 A1
(43) Pub. Date: Sep. 6, 2018

(54) POWER TAKEOFF UNIT WITH ACTUATION AND LUBRICATION FLUID CHANNELS

(71) Applicant: WPT Power Corporation, Wichita Falls, TX (US)

(72) Inventors: John G. Boland, Wichita Falls, TX (US); Robert De Hoyos, Wichita Falls, TX (US); Bryan Schaffner, Wichita Falls, TX (US)

(21) Appl. No.: 15/451,222

(22) Filed: Mar. 6, 2017

(51) Int. Cl. F16D 13/52; B60K 17/28; B60K 17/02; F16D 13/68; F16D 25/08; F16D 13/74

(52) U.S. Cl. CPC F16D 13/52; B60K 17/28; F16D 13/74; F16D 13/683; F16D 25/08; B60K 17/02

(57) ABSTRACT

A power takeoff (PTO) clutch unit for connection to an engine flywheel has interleaved friction disks and center plates for transfer of power to an output shaft. A pair of anti-friction bearings support the output shaft. Actuation fluid and in some cases lubrication fluid are provided at a rotary union adjacent the bearings. A spring assembly biases the PTO to a disengaged position. Gland rings are positioned about the output shaft on either side of the rotary union to allow passage of pressurized actuating and lubricating fluid to the bearings.

### TECHNICAL FIELD

The disclosed apparatus is generally in the field of power transmission devices and, more particularly, relates to power takeoff units. Specifically disclosed is a fluid actuated power takeoff clutch assembly having an advantageous seal and bearing arrangement.

### BACKGROUND

Clutches couple and transfer power from a power source, such as an engine, to driven equipment. Multi-disk power take off clutches are often hydraulically powered, using hydraulics to engage the driven and driving disks. Disk clutches can suffer abuse when engaged under high inertial load.

### BRIEF DESCRIPTION OF THE DRAWINGS

For an understanding of the objects, techniques and structure of the disclosure reference should be made to the following detailed description and accompanying drawings wherein:

FIG. 1 is a cross sectional view of a power takeoff clutch unit according to the disclosure; and

FIG. 2 is a partial cross sectional view of the PTO unit of FIG. 1.

### DETAILED DESCRIPTION OF THE DISCLOSURE

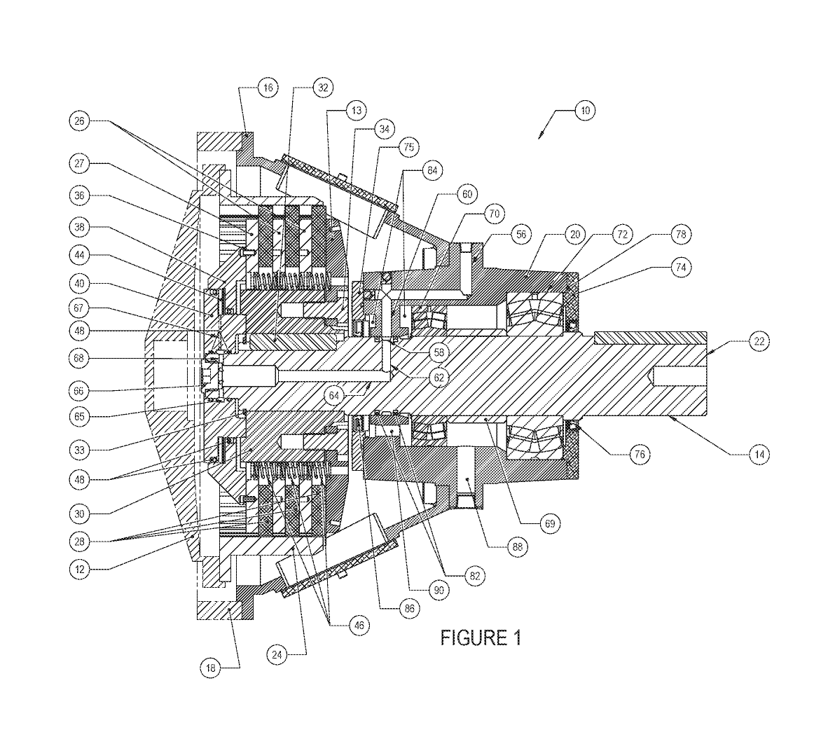

Referring now to the drawings and more particularly FIG. 1, it can be seen that a compact dry hydraulic power takeoff clutch unit made in accordance with the disclosure is designated generally by the numeral 10. The clutch unit 10 is adapted to be interposed between a power source which, in the preferred embodiment, is an engine flywheel 12, and an output coupler 14 or the like. The clutch housing 16 is circumferentially bolted to the engine flywheel housing 18 at one end thereof and to a bearing housing 20 at the opposite end thereof. The clutch housing 16 and bearing housing 20 receive the output shaft 22 and its support structure.

A drive ring 24 is bolted to the periphery of the flywheel 12 and splined to the outer circumferential surface of the friction disks 28. Interposed between the friction disks 28 are center plates 28. Any number of friction disks and center plates may be employed; shown are three friction disks 28 and two center plates 26.

An output hub 30 is secured to the output shaft 22 by a key 32 and maintained on the shaft 22 by retaining ring 33. A connector 34 fixedly attaches a backplate 13 to the hub 30. A connector 36 fixedly connects the floating plate 27 to the cylinder 38 which are mounted to move axially along the hub 30 at the splined connection. The center plates 26 are axially movable on the hub 30 by a splined connection, as shown.

A piston 40 is secured to an end of the shaft 22 and is received in an annular recess within the cylinder 38, a pressure cavity 44 defined between them for receipt of actuating fluid that is operative to axially move the piston 40 to engage the stack of friction disks 28 and center plates 26 to drive the output shaft 22, as known in the art. The cylinder 38 is mounted for axial movement between engaged and disengaged positions.

Biasing springs 46 are interposed between the backplate 13 and cylinder 38 to return the cylinder 38 when hydraulic pressure is reduced, such that the friction disks 28 and center plates 26 can disengage. Appropriate seals 48 are positioned between the combinations of the shaft 22, cylinder 38, piston 40, and plug 66 as shown to preclude leakage of actuating fluid.

Biasing springs 46 assure separation between the friction disks 28 and center plates 26 when the clutch is disengaged. The biasing springs 46 are aligned axially and act upon shoulders defined on each of the friction disks 28 and the backplate 13. The springs 46 assure separation between the disks and plates and bias the assembly to the disengaged position.

An appropriate speed or rpm sensor can be positioned in communication with the drive ring 24, flywheel 12, hub 30, output shaft 22, or other rotary element to monitor the input speed of the engine or the output speed of the clutch assembly 10. The signals generated by the sensor can be passed to an appropriate controller such as a dedicated microprocessor or the like for controlling the engagement and disengagement of the clutch 10.

A controller typically including a pressure reducing valve, solenoid valve, orifice, pressurized fluid source and accumulator, allows for controlled flow of the actuating fluid through the bearing housing 20 and the rotatable shaft 22 and to the pressure cavity 44. The controller fluidly communicates through an inlet 56 with, for example, the hydraulic system of the engine associated with the flywheel 12. An accumulator can be positioned downstream of an orifice to control the rate of pressure buildup from the orifice, allowing for consistent “bumping” during clutch engagement irrespective of actuating fluid temperature or viscosity.

A circumferential groove 58 is provided about the shaft 22 to communicate actuating fluid through a bore 60 in the bearing housing 20. Pressurized fluid is passed through the bore 60, into the circumferential groove 58, and into the radial bore 62 provided in the shaft 22, which is in further fluid communication with the axial bore 64. A plug 66 is provided at the end of the bore 64, as shown. A diametric bore 68 intersects the bore 64 and communicates actuating fluid to circumferential groove 65 defined between the shaft 22 and piston 40. Fluid communication from the groove 65 to the pressure cavity 44 is provided by a radial passageway 67 defined through the piston 40. Actuation of the clutch is achieved through the circumferential groove 58, bore 60, radial bore 62, the axial bore 64, diametric bore 68, circumferential groove 65, and radial passageway 67 into the pressure cavity 44.

Bearings 70 and 72 are provided adjacent the rotary union interface, spaced apart by spacer 69, and fully support the shaft 22.

The housing 16 and bearing housing 20 are sealed at the output end by a seal cover 74 and at the input end by a seal cover 75. Appropriate shaft seals 76, 86 are provided on opposite sides of the bearings 70, 72, as shown. Finally, a seal 78 is interposed between the seal cover 74 and the bearing housing 20. A passageway 91 provides fluid communication from the input port 56 to the bearing 72 in some embodiments for lubrication. In some embodiments, the actuation fluid may also serve as a lubricating fluid for the bearings 70, 72. In other embodiments, the bearings 70, 72 are grease lubricated and appropriately sealed.

Gland rings 82 are provided on each side of the circumferential groove 58.

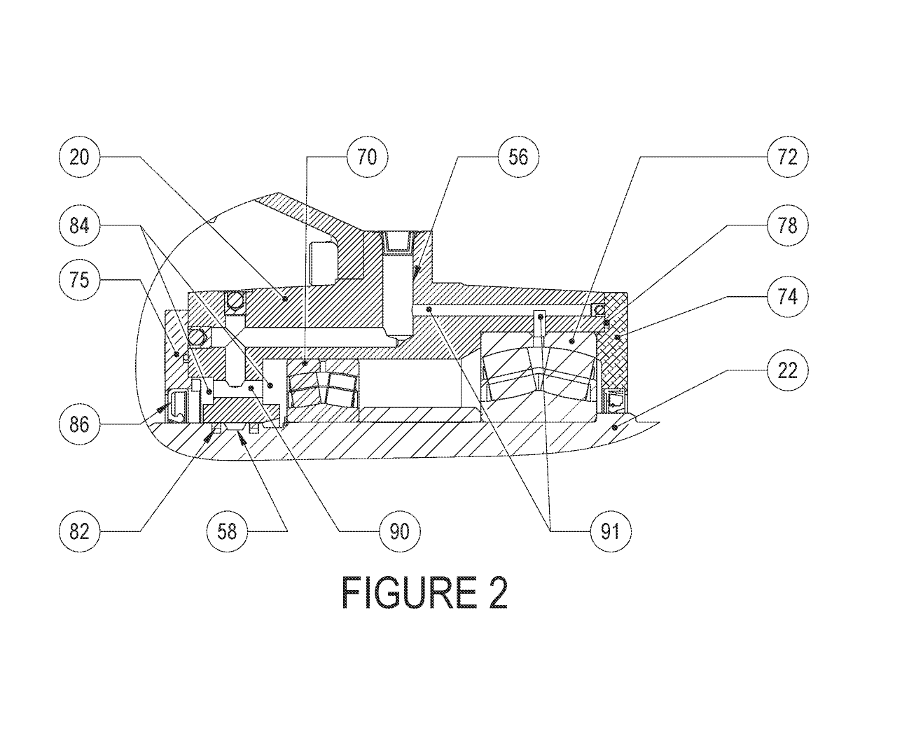

As shown in FIG. 2, actuating fluid from the circumferential groove 58 that passes through the gland rings 82 is received in the adjacent cavities 84. An axial bore 90 interconnects the two cavities 84 to a drain port 88.

The disclosure is not limited to the particular and exemplary embodiments described herein, from which a person of skill in the art will recognize that changes, additions, and omissions can be made without departing from the spirit of the inventions, which are defined and limited only be the appended claims.

It is claimed:

1. A fluid-actuated power takeoff clutch unit for connection with the flywheel of an engine, comprising:
a rotary drive ring for attachment to the flywheel of the engine;
a plurality of friction disks splined for axial movement to the drive ring;
a plurality of center plates interposed between the friction disks for selective engagement therewith and attached to an output hub;
the output hub splined for axial movement to an output shaft;
a pair of antifriction bearings supporting the output shaft;
an input port defined in a housing for providing actuating fluid to a circumferential groove defined about the output shaft, the groove providing fluid communication to an axial passageway in the output shaft, the axial passageway providing fluid communication to an actuating cavity defined between a cylinder fixedly attached to the output shaft and an axially movable piston operable to axially move the plurality of center plates;
a pair of gland ring seals positioned about the shaft, adjacent the pair of antifriction bearings, and on opposite sides of the circumferential groove.

2. The fluid-actuated power takeoff clutch unit of claim 1, wherein the circumferential groove is defined in the output shaft.

3. The fluid-actuated power takeoff clutch unit of claim 1, further comprising a radial passageway defined through the cylinder for providing fluid communication from the axial passageway of the shaft to the actuating cavity.

4. The fluid-actuated power takeoff clutch unit of claim 1, further comprising a diametric bore defined through the output shaft and intersecting with the axial passageway of the output shaft.

5. The fluid-actuated power takeoff clutch unit of claim 1, further comprising lubrication passageways for communication of actuating fluid passing through the gland seals to the pair of antifriction bearings.
